(19) United States
(12) Patent Application Publication
(10) Pub. No.: US 2005/0238191 A1
(43) Pub. Date: Oct. 27, 2005

(54) Acoustic testing devices and methods

(75) Inventor: Chen-Fun Hsu, Taichung County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/102,695

(22) Filed: Apr. 11, 2005

(30) Foreign Application Priority Data
Apr. 13, 2004 (TW) 093110208

(51) Int. Cl. H04R 25/00

(52) U.S. Cl. 381/318

(57) ABSTRACT

An acoustic testing device and method. The acoustic testing device tests acoustics of a speaker of an electrical device, and includes a first member and a second member. The speaker is disposed in the first member. The second member is combined with the first member, and includes a sound case with an adjustable size. The method includes the following steps. The speaker is first disposed in the device. Then, the acoustics of the speaker are tested by adjusting the size of the sound case until the acoustics of the speaker meets a predetermined value.

### BACKGROUND

The invention relates to acoustic testing devices, and in particular, to acoustic testing devices capable of simulating the acoustics of a speaker in an electronic device.

Multimedia is widely used in a recent electronic device. For example, nowadays, mobile phones comprise images, music, Internet functions. Additionally, the sound of the mobile phone becomes chord from single tone.

Speakers in mobile phones or other electronic devices have different resonant frequencies in different spaces. The acoustics of the speaker additionally depend on the space behind and in front of the speaker. Typically, acoustics in a speaker are simulated by software or a mechanism. Software is considered convenient but inaccurate, while mechanisms are considered more accurate but more complicated.

Additionally, typical methods are difficult to achieve in real time. Thus, the designer may not obtain immediate test results.

### SUMMARY

An acoustic testing device is provided. An exemplary embodiment of an acoustic testing device for testing the acoustics of a speaker, comprises a first member and a second member. The first member receives the speaker. The second member is combined with the first member, and comprises a first sound case with an adjustable size. The acoustics of the speaker are tested by adjusting the size of the first sound case.

Furthermore, some embodiments of an acoustic testing device comprise a moveable member, a seal member, and a signal generator. The moveable member is disposed in the second member to adjust the size of the first sound case. The seal member may be rubber. The second member comprises a hole and a groove. The signal generator is disposed in the groove of the second member to actuate the speaker to generate sound.

Additionally, the first member comprises a hole so that the speaker and the first sound case are communicated with each other via the hole. The first member comprises a cover in which the hole is formed.

It is noted that the second member may be a transparent material, and comprises a plurality of scales.

Moreover, some embodiments of an acoustic testing device further comprise a third member, a moveable member, a bolt, and a nut. The third member, comprising a hole, a plurality of scales, and a second sound case with an adjustable size, is combined with the first member. The moveable member is disposed in the third member to adjust the size of the second sound case. The third member may be transparent material. The bolt is disposed on the second member to combine the first member, the second member, and the third member. The nut is combined with the bolt. The first member comprises a first through hole, and the third member comprises a second through hole. The bolt passes through the first through hole and the second through hole.

### DESCRIPTION OF THE DRAWINGS

Acoustic testing devices and methods can be more fully understood by reading the subsequent detailed description and examples with references made to the accompanying drawings, wherein:

FIG. 1a is an exploded view of an embodiment of an acoustic testing device;

FIG. 1b is a schematic view of the assembled device in FIG. 1a;

FIG. 2 is another schematic view of the acoustic testing device in FIG. 1a;

FIG. 3 is a schematic view of a seal member in FIG. 2; and

FIG. 4 is a flow chart of an embodiment of an acoustic testing method.

### DETAILED DESCRIPTION

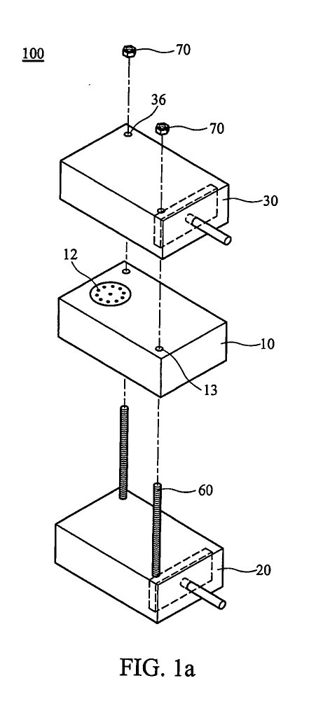

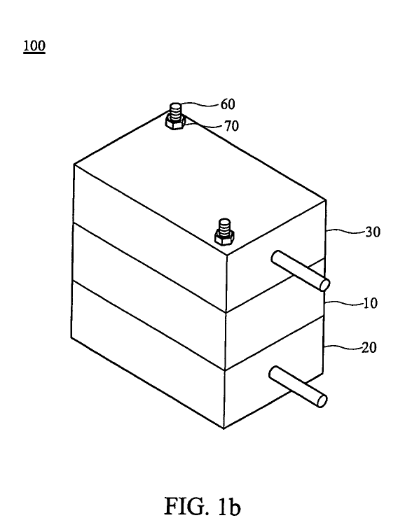

FIGS. 1a, 1b and 2 depict an embodiment of an acoustic testing device 100. An embodiment of the acoustic testing device 100 tests the acoustics of a speaker 1, and comprises a first member 10, a second member 20, a third member 30, a seal member 40, a signal generator 50, two bolts 60, and two nuts 70.

Referring to FIG. 2, the first member 10 receives the speaker 1, and comprises a detachable cover 11. The speaker 1 is disposed in the first member 10, it is subsequently secured by the cover 11. Furthermore, as shown in FIGS. 1a and 2, the cover 11 comprises a plurality of first holes 12 so that the speaker 1 in the first member 10 can communicate with the exterior of the first member 10, such as the second member 20, via the first holes 12. Additionally, as shown in FIG. 1a, the first member 10 comprises two first through holes 13 at two corners respectively.

The second member 20 is detachably combined with the first member 10, and comprises a first moveable member 22 and a first sound case 21 with an adjustable size. The first moveable member 22 is moveably disposed in the second member 20 to adjust the size of the first sound case 21. Furthermore, the second member 20 comprises a plurality of second holes 23 so that the acoustics of the speaker 1 can spread to the exterior via the first holes 12 and the second holes 23. Note that only one second hole 23 is shown in FIG. 2. Additionally, the second member 20 may be made of transparent material, and comprises a plurality of first scales 24 on the outer surface thereof. Thus, it is convenient to observe the change of the first sound case 21 of the second member 20.

The third member 30 is detachably combined with the first member 10, and comprises a similar structure as the second member 20 except that a groove 31 is formed. Specifically, the third member 30 comprises a second moveable member 33 and a second sound case 32 with an adjustable size. The second moveable member 33 is moveably disposed in the third member 30 for adjusting the volume size of the second sound case 32. Furthermore, the third member 30 comprises a plurality of third holes 34 allowing the acoustics of the speaker 1 to spread to the exterior via the first holes 12 and the third holes 34. Note that only one third hole 34 is shown in FIG. 2. Additionally, the third member 30 may be transparent material, and comprises a plurality of second scales 35 on the outer surface thereof. Thus, it is convenient to observe the volume change of the second sound case 32 of the third member 30. Additionally, as shown in FIG. 1a, the third member 30 comprises two second through holes 36 at two corners respectively.

While an embodiment of the acoustic testing device 100 comprises three members 10, 20, 30 representing that the speaker 1 is disposed in an electronic device with a front sound case and a rear sound case, it is not limited thereto, and may comprise two members by omitting the second member 20 or the third member 30. At this time, the speaker 1 to be tested is disposed in an electronic device with only one sound case.

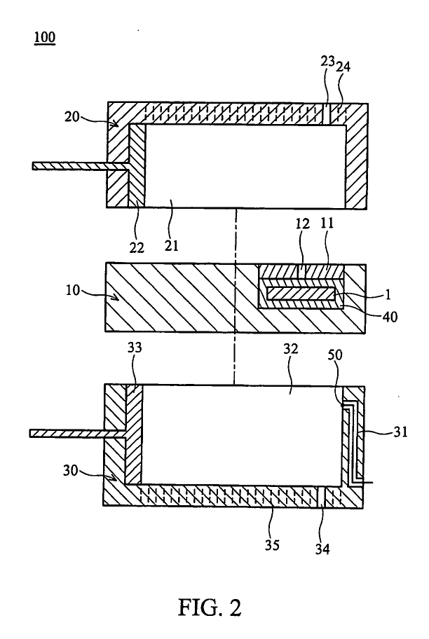

The seal member 40 is disposed in the first member 10 to surround the speaker 1 to maintain the airtight seal of the speaker 1. Preferably the seal member 40 is rubber. Furthermore, as shown in FIG. 3, when the speaker 1 is cylindrical, the seal member 40 may comprise a plurality of rings to achieve an airtight seal.

The signal generator 50 is disposed in the groove 31 of the third member 30 to actuate the speaker 1 to generate sound during test. Thus, a receiver (not shown), such as a microphone, can test the sound level of the speaker 1. While the signal generator 50 is disposed in the third member 30 in this embodiment, it is not limited thereto, and may be disposed on the second member 20 based on requirements.

Each bolt 60 is disposed on the second member 20, and passes through the first through hole 13 of the first member 10 and the second through hole 36 of the third member 30 to combine the first member 10, the second member 20, and the third member 30. Each nut 70 is combined with the corresponding bolt 60 so that the first member 10, the second member 20, and the third member 30 are closely adjacent.

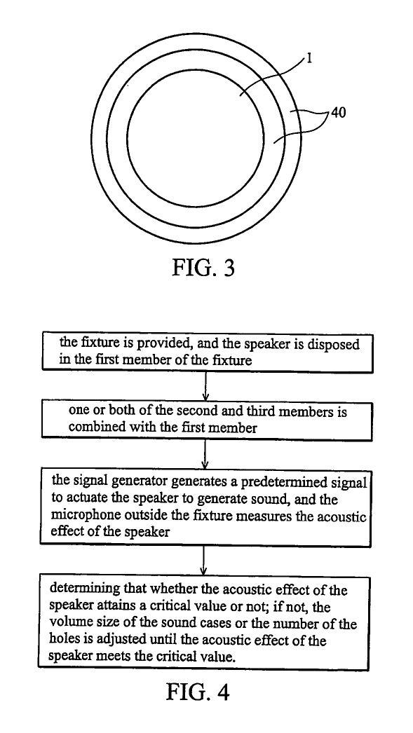

Referring to FIG. 4, an embodiment of an acoustic testing method comprises the following steps. The speaker 1 is disposed in the first member 10 of the acoustic testing device 100. Based on the situation to be simulated, one or both of the second and third members 20 and 30 are combined with the first member 10. The signal generator 50 generates a predetermined signal to actuate the speaker 1 to generate sound. The microphone outside the acoustic testing device 100 tests the acoustics of the speaker 1 to determine whether the acoustics thereof have attained a critical value (a standard value) or not. If not, the size of the sound cases 21, 32 or the number of the holes 12, 23, 35 is adjusted until the acoustics of the speaker meets the critical value. Thus, the sound case around the speaker can be designed.

It is understood that when the size of the sound cases 21, 32 and the number of the holes 12, 23, 35 can be adjusted together at the same time, or separately at different times. Additionally, the size of the sound cases 21, 32 may be adjusted together or separately.

In this embodiment, the acoustic testing device is cheap, and is convenient for the operator to attain the simulated result rapidly. Additionally, the simulated result is more accurate. Furthermore, since the acoustic testing device is easy to be disassembled, it is easy to use in any conditions.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A device for testing acoustics of a speaker, comprising:
a first member receiving the speaker; and
a second member, combined with the first member, comprising a first sound case with an adjustable size, wherein the acoustics of the speaker are tested by adjusting the size of the first sound case.

2. The device as claimed in claim 1, further comprising a moveable member disposed in the second member for adjusting the size of the first sound case.

3. The device as claimed in claim 1, wherein the first member comprises a hole so that the speaker and the first sound case are communicated with each other via the hole.

4. The device as claimed in claim 3, wherein the first member comprises a cover in which the hole is formed.

5. The device as claimed in claim 1, further comprising a seal member, surrounding the speaker, disposed in the first member.

6. The device as claimed in claim 5, wherein the seal member is made of rubber.

7. The device as claimed in claim 1, wherein the second member comprises a hole.

8. The device as claimed in claim 1, wherein the second member is made by transparent material, and comprises a plurality of scales.

9. The device as claimed in claim 1, further comprising a signal generator disposed in the second member to actuate the speaker to generate sound.

10. The device as claimed in claim 9, wherein the second member comprises a groove in which the signal generator is disposed.

11. The device as claimed in claim 1, further comprising a third member, combined with the first member, comprising a second sound case with an adjustable size.

12. The device as claimed in claim 11, wherein the third member comprises a hole.

13. The device as claimed in claim 11, further comprising a moveable member disposed in the third member to adjust the size of the second sound case.

14. The device as claimed in claim 11, wherein the third member comprises transparent material, and a plurality of scales.

15. The device as claimed in claim 11, further comprising a bolt disposed on the second member to combine the first member, the second member, and the third member.

16. The device as claimed in claim 15, further comprising a nut combined with the bolt.

17. The device as claimed in claim 15, wherein the first member comprises a first through hole, the third member comprises a second through hole, and the bolt passes through the first through hole and the second through hole.

18. A method for testing acoustics, comprising:
providing a device comprising a sound case with an adjustable size;
placing a speaker in the device;
testing the acoustics of the speaker; and
adjusting the size of the sound case until the acoustics of the speaker meet a predetermined value.

19. The method as claimed in claim 18, wherein the device comprises a plurality of holes, and the number of the holes is adjusted when the size of the sound case is adjusted.

20. The method as claimed in claim 18, further comprising:
providing a microphone to test the acoustics of the speaker.
